(19) United States
(12) Patent Application Publication
(10) Pub. No.: US 2023/0356424 A1
(43) Pub. Date: Nov. 9, 2023

(54) METHOD FOR FEEDING A MATERIAL STRIP TO THE MACHINING ZONE OF A MACHINE TOOL

(71) Applicant: BRUDERER AG, Frasnacht (CH)

(72) Inventors: Manuel BÜHLER, Arbon (CH); Ugo DE SANTIS, Roggwil (CH)

(21) Appl. No.: 18/246,453

(22) PCT Filed: Sep. 25, 2020
(86) PCT No.: PCT/EP2020/076989

§ 371 Date: Mar. 23, 2023

(51) Int. Cl. B26D 7/06; B26F 1/14

(52) U.S. Cl. CPC B26D 7/06; B26F 1/14

(57) ABSTRACT

A method for feeding a material strip to the processing zone of a punch press, wherein the material strip is clamped between a pair of feed rollers and is fed intermittently by rotating the feed rollers at intervals, and wherein the following steps are carried out after each feed of the material strip and before the next feed of the material strip in a feed pause with the material strip stationary and clamped between the feed rollers: holding the material strip by fixing the feed rollers with a certain holding torque; temporarily reducing or eliminating the holding torque of the feed rolls; positioning the strip of material with the holding torque of the feed rollers reduced or removed by inserting one or more pilot pins into associated pilot holes in the strip of material, the strip of material being displaced by the pilot pin or pins and the feed rollers being rotated by the strip of material clamped between them as it is displaced, optionally overcoming the reduced holding torque; and re-extending the pilot pin(s) from the pilot holes of the material belt. This method makes it possible to achieve a highly precise strip feed even without complex intermediate lifting mechanisms.

### CROSS-REFERENCE TO RELATED APPLICATION

This application is a National Stage application of International Patent Application No. PCT/EP2020/076989, filed on Sep. 25, 2020, which is hereby incorporated by reference in its entirety.

### TECHNICAL FIELD

The present invention relates to a method for feeding a material strip to the machining zone of a machine tool, a feed apparatus for use in carrying out the method, and a machine tool comprising the feed apparatus according to the preambles of the independent patent claims.

### BACKGROUND

For machine tools on which a material strip is machined in several steps, it is often necessary to precisely maintain a certain feed rate. Particularly in the case of automatic punching machines, on which products are punched out of a material strip in a subsequent cutting process, extremely small tolerances are required, which can no longer be ensured via the control of the feed rollers of the feed apparatuses used.

In order to be able to maintain the required tolerances here, the clamping of the material strip between the feed rolls is temporarily released so that the material strip is temporarily free to move. This process is also known as “intermediate lifting”. In this free-moving state, pilot pins are then inserted into assigned pilot openings in the material strip which then precisely position the material strip. Before the pilot pins are moved out of the pilot openings, the material strip is clamped again between the feed rolls so that it is fixed in a precisely aligned state.

Although this known process enables high-precision strip processing with regard to the feed dimension, it has the disadvantage that the feed apparatus required for this purpose is mechanically very complex and correspondingly expensive and high-maintenance.

### SUMMARY

The task here is therefore to provide a technical solution that does not have the disadvantages of the prior art described above or at least partially avoids them.

This task is solved by the objects of the independent patent claims.

According to these, a first aspect of the invention relates to a method for feeding a material strip to the machining zone of a machine tool, preferably to the machining zone of an automatic punching machine.

The material strip is permanently clamped between at least one pair of feed rollers and advanced by rotating the feed rollers at intervals. There is therefore no intermediate lifting of the feed rolls. After each advance of the material strip, the following steps are carried out in the feed pause until the next advance of the material strip:
a) holding the material strip by fixing the feed rollers with a certain holding torque.
b) temporarily reducing or eliminating the holding torque of the feed rolls.
c) positioning of the material strip with reduced or cancelled holding torque of the feed rollers by insertion of one or more pilot pins into assigned pilot openings in the material strip. If the material strip deviates from the nominal position or the pilot pins and the pilot openings are not congruent, the material strip is displaced by the pilot pin(s) and the feed rolls are rotated by the material strip clamped between them as it is displaced, if necessary by overriding the reduced holding torque.
d) re-extending the pilot pin(s) from the pilot holes of the material belt.

The method according to the invention makes it possible to achieve a highly precise strip feed even without complex intermediate lifting mechanisms.

If the holding torque is temporarily reduced to a certain value greater than zero in process step b), the material strip can only be moved by overcoming the reduced holding torque. If the holding torque is temporarily removed, the material belt is free to move in and against the feed direction.

In a preferred variant of the process, the pilot pin(s) is/are moved out of the pilot openings of the material strip again while the holding moment of the feed rollers is temporarily reduced or cancelled. This prevents the pilot pins from jamming if the feed rollers are moved when the holding moment is reduced or cancelled again. It is then also possible to cancel the reduction or cancellation of the holding torque by driving the feed rollers with a specific drive torque for the purpose of feeding the material strip, without having to restore the original holding torque beforehand when the machine is at a standstill.

In a preferred variant of the process, the temporary reduction or cancellation of the holding torque of the feed rollers is cancelled again before the pilot pin or pins are moved out of the pilot openings of the material strip again, preferably by restoring the original holding torque. Here it can be prevented that the feed rolls move when the reduction or cancellation of the holding torque is resumed.

In a further preferred embodiment of the process, the material strip is displaced in the feed direction during positioning with the pilot pin or pins. This is particularly advantageous when very thin material strips are processed and a reduced holding torque is used, because in this way buckling of the material strip can be avoided.

The feed rolls are preferably driven by one or more servo motors. Servo motors are particularly suitable for this purpose because they can be precisely controlled in terms of their drive and holding torques as well as their rotational positions.

It is preferred that the servo motor(s) and thus the feed rollers driven by them are controlled by a control system for each feed interval according to a predefined target motion and standstill profile.

It is particularly advantageous if the actual movement and standstill profile of the servo motor(s) or the feed rollers is monitored and the target movement and standstill profile of a subsequent feed interval, in particular the next feed interval, is shifted in such a way that the target position of the servo motor(s) or the feed rollers at the beginning of this shifted target movement and standstill profile corresponds to the actual position of the servo motor(s) or the feed rollers after positioning of the material strip with the pilot pin(s). In this way, setpoint tracking is then performed after each feed interval, which prevents setpoint deviations from accumulating over several feed intervals.

Advantageously, the machine tool is a punch press, whereby the nominal motion and standstill profile of the servo motor(s) or the feed rollers is synchronized with the motion profile of the press ram.

It is preferred that the synchronization is carried out as a so-called relative synchronization, in which the executed part of the target motion and standstill profile of the servo motor(s) always matches the executed part of the motion profile of the press ram, viewed relatively. If the press is within a feed step and the feed is synchronized in this way, then the servomotor or servomotors continue at the correct position of the nominal movement and standstill profile, i.e. it is only advanced by the “residual length”. The “residual length” is moved synchronously with the movement profile of the press ram. Accordingly, the servo motor or the feed rollers can be started and stopped as required in the nominal motion and standstill profile.

In yet another preferred embodiment of the method, after the pilot pin or pins have been moved out of the pilot openings of the material belt and while the reduction of the holding torque of the feed rolls is cancelled, the feed rolls are monitored for any rotational movement. If a setpoint tracking is carried out as described above, in which the setpoint movement and standstill profile of the next feed interval is shifted in such a way that the setpoint position of the servo motor(s) or the feed rollers at the beginning of this shifted setpoint movement and standstill profile corresponds to the actual position of the servo motor(s) or the feed rollers after positioning of the material strip with the pilot pin(s), it is preferred that the monitoring begins with the start of the setpoint tracking and ends after completion of the reduction or cancellation of the holding torque, i.e. when the normal holding torque is restored. If an overshoot of a certain max. permissible torsion angle is detected, the press is stopped automatically and, advantageously, the detected torsion angle which has led to the press stop is communicated to the operator of the press via the press control system so that he can carry out a specific fault analysis.

A second aspect of the invention relates to a feeding apparatus for use in carrying out the method according to the first aspect of the invention. The feeding apparatus comprises at least one pair of feeding rollers between which the material strip can be clamped and by means of which it can be fed intermittently by rotating the feeding rollers at intervals and can be held in the feeding pauses with the material strip stationary and clamped between the feeding rollers by fixing the feeding rollers with a certain holding torque. The feed apparatus is designed in such a way that in the feed pauses when the material strip is stationary and clamped between the feed rollers, the holding torque of the feed rollers can be temporarily reduced or cancelled when holding the material strip, so that the material strip can be displaced by forces acting on the material strip, with the feed rollers clamping the material strip being rotated by the material strip clamped between them.

With the feed apparatus according to the invention, it is possible to achieve a high-precision strip feed even without complex intermediate lifting mechanics.

In a preferred embodiment, the feed apparatus is designed in such a way that the holding torque can be temporarily reduced to a certain value greater than zero. This means that the material strip can only be moved by overcoming the reduced holding torque.

In an alternative preferred embodiment, the feed apparatus is designed in such a way that the holding torque can be temporarily cancelled.

Depending on the machining process and operational conditions, one or the other alternative may be more preferable.

The feed rollers of the feed apparatus are advantageously driven by one or more servo motors. Servomotors are particularly suitable for the purpose because they can be precisely controlled in terms of their drive and holding torques as well as their rotational positions.

It is preferred that the servo motor(s) and thus the feed rollers driven by them can be controlled per feed interval by a control system according to a predefined target motion and standstill profile.

A third aspect of the invention relates to a machine tool comprising a feed apparatus according to the second aspect of the invention, preferably for carrying out the method according to the first aspect of the invention. The machine tool comprises a controller with which the servo motor or motors or the feed rollers can be controlled per feed interval according to a predetermined desired motion and standstill profile.

Preferably, the machine tool or a tool associated with this machine has one or more pilot pins for insertion into associated pilot openings in the material strip for the purpose of positioning the material strip when the holding torque is temporarily reduced or removed.

The control is designed in such a way that the actual movement and standstill profile of the servo motor or the feed rollers of the feed apparatus can be monitored and the target movement and standstill profile of a following feed interval of the feed apparatus, preferably the next feed interval, can be shifted in such a way that the target position of the servo motor or the feed rollers at the beginning of this shifted target movement and standstill profile corresponds to the actual position of the servo motor or the feed rollers after positioning of the material strip with the pilot pin or pins.

In this way, setpoint tracking can be performed after each feed interval, which prevents setpoint deviations from accumulating over several feed intervals.

In a particularly preferred embodiment, the machine tool is a punch press, whereby the target motion and standstill profile of the servo motor or the feed rollers can be synchronized with the motion profile of the press ram.

It is preferred that the synchronization is executed as a so-called relative synchronization, in which the executed part of the target motion and standstill profile of the servo motor(s) always matches the executed part of the motion profile of the press slide, viewed relative to each other. If the press is within a feed step and the feed is synchronized in this way, it is continued at the correct point of the nominal movement and standstill profile of the servomotor(s), i.e. it is only advanced by the “remaining length”. The “remaining length” is moved synchronously with the movement profile of the press ram. Accordingly, the servo motor or the feed rollers can be started and stopped as required in the target motion and standstill profile.

In yet another preferred embodiment, the machine tool is designed in such a way that, after the pilot pin or pins have been moved out of the pilot openings of the material strip and during the raising of the reduction of the holding torque of the feed rollers of the feed apparatus, the feed rollers can be monitored for any rotary movement, and that, if a certain maximum permissible angle of rotation is thereby determined to be exceeded, the press can be stopped automatically and, advantageously, the determined angle of rotation which has led to the press stop can be communicated to the operator of the press via the press control system so that he can carry out a specific fault analysis.

If a setpoint tracking is carried out as described above, in which the setpoint motion and standstill profile of the next feed interval is shifted in such a way that the setpoint position of the servo motor(s) or the feed rollers at the beginning of this shifted setpoint motion and standstill profile corresponds to the actual position of the servo motor(s) or the feed rollers after the positioning of the material strip with the pilot pin(s), it is preferred that the monitoring starts with the start of the setpoint tracking and ends after the reduction or cancellation of the holding torque, i.e. when the normal holding torque is restored.

### BRIEF DESCRIPTION OF THE DRAWINGS

Further preferred embodiments of the invention are shown in the dependent claims and in the following description based on the figures:

FIG. 1A shows the curves of the press stroke of a punching press with crank drive and pilot pins over the crank angle of the press during the application of a first method;

FIG. 1B shows the curves of the actual motion and standstill profile of the feed rolls of a punching press with crank drive and pilot pins over the crank angle of the press during the application of a first method;

FIG. 1C shows the curves of the target motion and standstill profile of the feed rolls of a punching press with crank drive and pilot pins over the crank angle of the press during the application of a first method;

FIG. 1D shows the curves of the position pilot pins of a punching press with crank drive and pilot pins over the crank angle of the press during the application of a first method;

FIG. 1E shows the curves of the holding or drive torque of the feed rolls of a punching press with crank drive and pilot pins over the crank angle of the press during the application of a first method;

FIG. 1F shows the curves of the setpoint tracking of a punching press with crank drive and pilot pins over the crank angle of the press during the application of a first method;

FIG. 1G shows the curves of the process monitoring of a punching press with crank drive and pilot pins over the crank angle of the press during the application of a first method;

FIG. 2A shows the curves of the press stroke of a punching press with crank drive and pilot pins over the crank angle of the press during the application of a second method;

FIG. 2B shows the curves of the actual motion and standstill profile of the feed rolls of a punching press with crank drive and pilot pins over the crank angle of the press during the application of a second method;

FIG. 2C shows the curves of the target motion and standstill profile of the feed rolls of a punching press with crank drive and pilot pins over the crank angle of the press during the application of a second method;

FIG. 2D shows the curves of the position pilot pins of a punching press with crank drive and pilot pins over the crank angle of the press during the application of a second method;

FIG. 2E shows the curves of the holding or drive torque of the feed rolls of a punching press with crank drive and pilot pins over the crank angle of the press during the application of a second method;

FIG. 2F shows the curves of the setpoint tracking of a punching press with crank drive and pilot pins over the crank angle of the press during the application of a second method;

FIG. 2G shows the curves of the process monitoring of a punching press with crank drive and pilot pins over the crank angle of the press during the application of a second method;

FIG. 3A shows the curves of the press stroke of a punching press with crank drive and pilot pins over the crank angle of the press during the application of a third method;

FIG. 3B shows the curves of the actual motion and standstill profile of the feed rolls of a punching press with crank drive and pilot pins over the crank angle of the press during the application of a third method;

FIG. 3C shows the curves of the target motion and standstill profile of the feed rolls of a punching press with crank drive and pilot pins over the crank angle of the press during the application of a third method;

FIG. 3D shows the curves of the position pilot pins of a punching press with crank drive and pilot pins over the crank angle of the press during the application of a third method;

FIG. 3E shows the curves of the holding or drive torque of the feed rolls of a punching press with crank drive and pilot pins over the crank angle of the press during the application of a third method; and

FIG. 3F shows the curves of the setpoint tracking of a punching press with crank drive and pilot pins over the crank angle of the press during the application of a third method.

### DETAILED DESCRIPTION

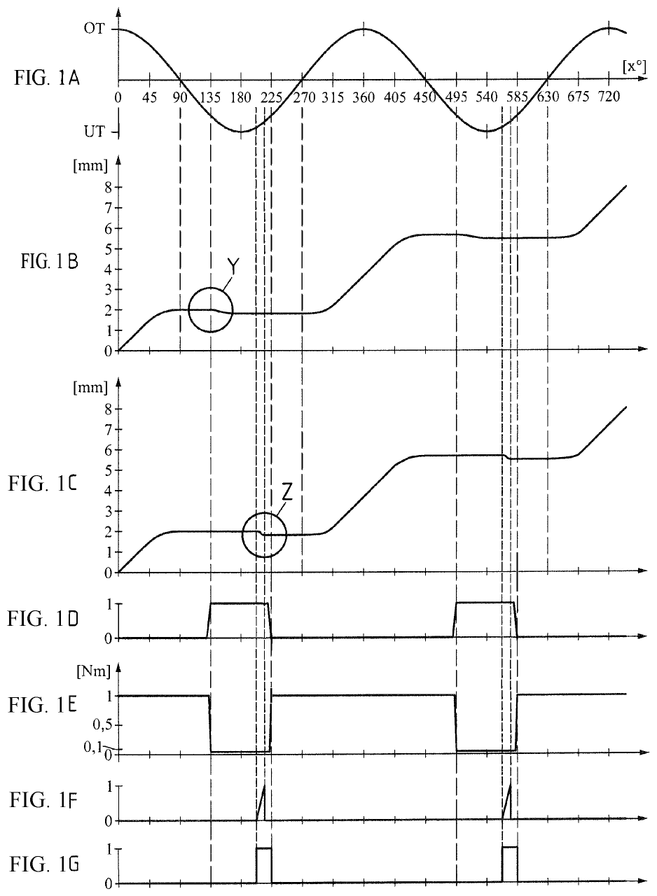

FIGS. 1A to 1G show the curves of various operating parameters of a punch press over the crank angle of the press in the application of a first method according to the invention for feeding a material strip to the processing zone of the punch press over two crankshaft revolutions or 720° crank angle X.

As can be seen from FIG. 1A, which shows the press stroke or ram position between top dead center OT and bottom dead center UT over the crank angle X, the press ram passes through the bottom dead center UT at 180° and 540°, and through the top dead center OT at 360° and 720°.

As can be seen from FIGS. 1B and 1C, which show the actual motion and standstill profile of the feed rolls (FIG. 1B) and the target motion and standstill profile of the feed rolls (FIG. 1C) in millimeters of the circumferential rotation of the feed rolls and thus in millimeters of the feed movement of the material band, an actual displacement of the material band by rotation of the feed rolls as shown in FIG. 1B takes place during passage through top dead center OT up to about 90° after OT in accordance with the specified target movement and standstill profile in FIG. 1C. From approx. 90° after OT, a feed pause begins which lasts until approx. 270° after OT or 90° after UT.

As can be seen from FIGS. 1D and 1E, which show the position of the pilot pins that are to be inserted into pilot openings in the material belt between the fully retracted position 0 and the position 1 fully inserted into the pilot openings (FIG. 1D) and show the course of the holding or drive torque of the feed rollers in Nm (FIG. 1E), movement of the pilot pins into the pilot openings begins during the feed pause shortly before 135° after OT or shortly before 45° before UT. During the moving in of the pilot pins, the holding or drive torque of the feed rolls, which was previously set to a constant 1 Nm, is reduced to a reduced holding torque of 0.1 Nm. Both processes, i.e. the insertion of the pilot pins into the pilot openings of the material band and the reduction of the holding torque, are completed at 135° after OT.

As can be seen from the course offset marked Y in FIG. 1B, which is shown enlarged for better visibility, when the pilot pins are moved into the pilot openings in the material strip, during which the material strip is brought into its definitive processing position, the material strip is pushed back against the feed direction and the feed rollers are turned back accordingly, while the target movement and standstill profile of the feed rollers remains unchanged, as shown in FIG. 1C.

The material strip is then punched around the bottom dead point UT, with the pilot pins fully inserted into the pilot holes in the material strip and the reduced holding torque of the feed rolls.

As can be seen from FIG. 1F, which shows the status of the setpoint tracking of the press control between “Off” 0 and “On” 1, the setpoint tracking is activated at approx. 200° after OT or approx. 20° after UT, which is closed at approx. 215° after OT or 35° after UT and then deactivated again.

As can be seen from the course offset marked Z in FIG. 1C, which is shown enlarged for better recognition, when the setpoint tracking is activated, the target movement and standstill profile of the directly following feed interval is shifted in such a way that the target position of the feed rollers at the beginning of this shifted target movement and standstill profile corresponds to the actual position of the feed rollers after the positioning of the material strip with the pilot pins. The pilot pins are fully inserted into the pilot openings in the material strip and the feed rolls are held with the reduced holding torque.

As can be seen from FIGS. 1D and 1E, the pilot pins are retracted after the setpoint correction at approx. 220° after OT or 40° after UT, and during the retraction of the pilot pins the holding torque of the feed rolls is increased again to the original value of 1 Nm. Both processes, i.e. the retraction of the pilot pins from the pilot openings of the material belt and the re-application of the holding torque, are completed at 225° after OT or 45° after UT.

As can be seen from FIG. 1G, which shows the status of the process monitoring with regard to an unintentional rotation of the feed rolls between “Off” 0 and “On” 1, this process monitoring is activated when the setpoint tracking is activated, i.e. at approx. 200° after OT or 20° after UT, and is deactivated after the pilot pins have been completely moved out of the pilot openings of the material strip and the holding torque has been restored to 1 Nm, i.e. at 225° after OT or 45° after UT.

If a rotation of the feed rolls is detected which exceeds a certain max. permissible angle of rotation, the press is automatically stopped and the operator is informed of the detected angle of rotation via the press control.

At about 270° after OT or 90° after UT, the feed pause ends and the material strip is advanced by rotation of the feed rolls, while the press ram moves upwards towards the upper dead point OT, which it reaches at 360° after OT or 180° after UT. From then on, the process described above starts again from the beginning.

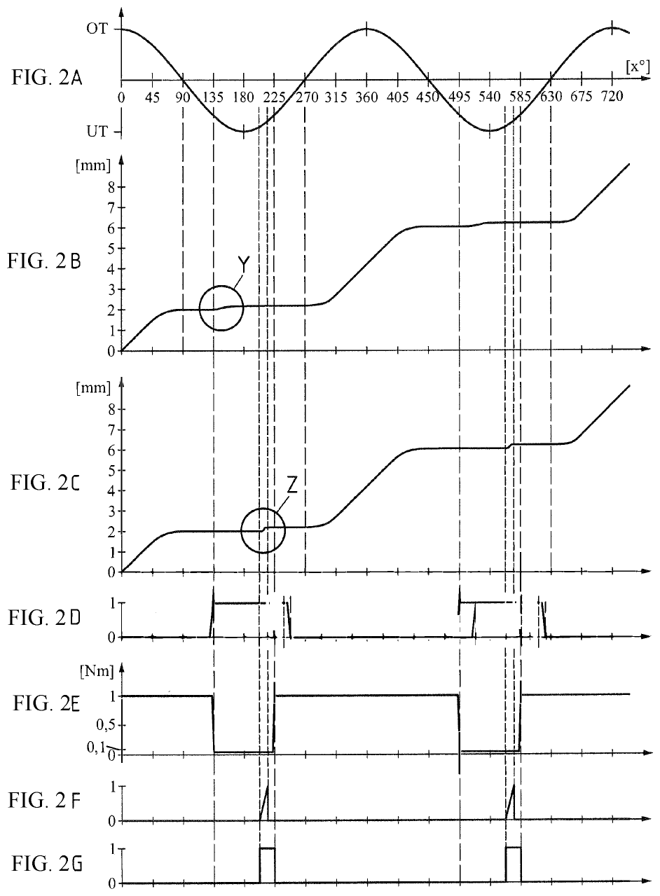

FIGS. 2A to 2G show the curves of various operating parameters of a punch press over the crank angle of the press when using a second method according to the invention for feeding a material strip to the processing zone of the punch press over two crankshaft revolutions or 720° crank angle X.

The method according to FIGS. 2A to 2G differs from the method according to FIGS. 1A to 1G only in that when the pilot pins are moved into the pilot openings of the material strip, during which the material strip is brought into its definitive processing position, the material belt is pulled or pushed forward in the feed direction and the feed rollers are correspondingly rotated forwards.

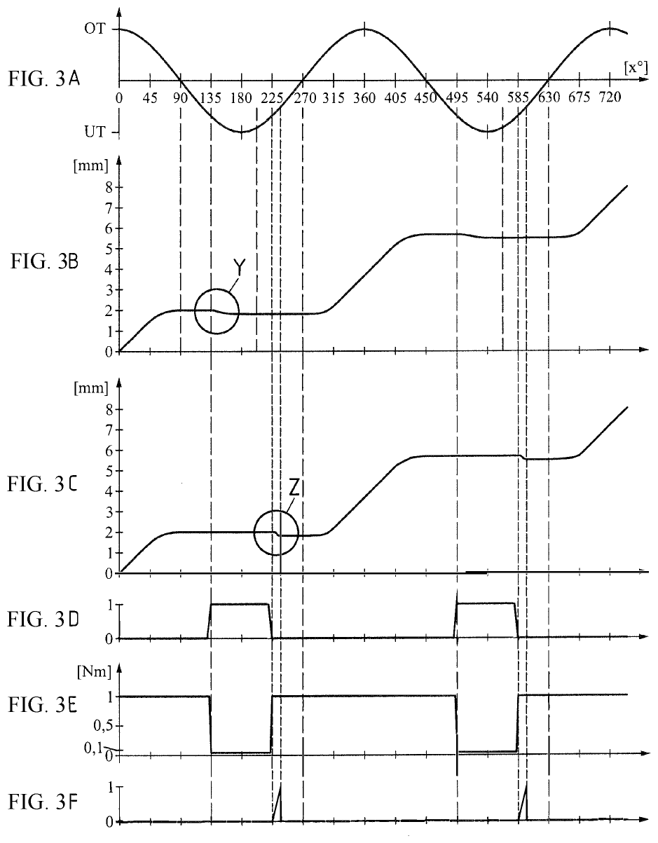

FIGS. 3A to 3F show the curves of various operating parameters of a stamping press over the crank angle of the press when using a third method according to the invention for feeding a strip of material to the processing zone of the stamping press over two crankshaft revolutions or 720° crank angle X.

The process according to FIGS. 3A to 3F differs from the process according to FIGS. 1A to 1G in that the setpoint tracking is activated after the pilot pins have been completely retracted and the holding torque of the feed rolls has increased again to the original value of 1 Nm. In this process, this is the case at approx. 225° after OT or 45° after UT. In this embodiment, the process monitoring according to FIG. 1G is also omitted.

While preferred embodiments of the invention are described in the present application, it should be clearly noted that the invention is not limited to these and may be carried out in other ways within the scope of the claims which now follow.

What is claimed is:

1. A method for feeding a material strip to the machining zone of a machine tool, in particular of an automatic punching machine, wherein the material strip is clamped between at least one pair of feed rollers and is advanced at intervals by rotating the feed rollers at intervals, and wherein the following steps are carried out after each advance of the material strip and before the next advance of the material strip in an advance pause with the material strip stationary and clamped between the feed rollers:
a) holding the material strip by fixing the feed rollers with a certain holding torque;
b) temporarily reducing or cancelling the holding torque of the feed rolls;
c) positioning the material strip with the holding torque of the feed rollers reduced or removed by inserting one or more pilot pins into associated pilot openings in the material strip, the material strip being displaced by the pilot pin or pins and the feed rollers being rotated by the material strip clamped between them as it is displaced, if applicable by overcoming the reduced holding torque; and
d) retracting the pilot pin(s) from the pilot holes of the material belt,
wherein the feed rollers are driven by a servomotor,
wherein the servomotor or the feed rollers per feed interval are controlled with a control system in accordance with a predetermined target movement and standstill profile,
wherein the actual movement and standstill profile of the servomotor or the feed rollers is monitored and the target movement and standstill profile of a subsequent feed interval, in particular the next feed interval, is shifted in such a way that the target position of the servomotor or of the feed rollers at the beginning of this shifted target movement and standstill profile corresponds to the actual position of the servomotor or of the feed rollers after positioning of the material strip with the pilot pin or pins,
wherein the machine tool is a punch press and wherein the target motion and standstill profile of the servo motor or the feed rollers is synchronized with the motion profile of the press ram.

2. The method of claim 1, wherein the retracting of the pilot pin(s) out of the pilot openings of the material strip occurs while the holding torque of the feed rollers is temporarily reduced or increased.

3. The method according to claim 1, wherein, before the retracting of pilot pin or pins out of the pilot openings of the material strip, the temporary reduction or cancellation of the holding torque of the feed rollers is cancelled again.

4. The method according to claim 1, wherein the material strip is displaced in the feed direction during positioning with the pilot pin or pins.

5. (canceled)

6. (canceled)

7. (canceled)

8. (canceled)

9. The method according to claim 1, wherein the synchronization is carried out as relative synchronization, so that in the target movement and standstill profile of the servo motor or the feed rollers, respectively, it is possible to start and stop as desired.

10. The method according to claim 1, wherein after the pilot pin or pins have been moved out of the pilot openings of the material strip and while the reduction of the holding torque of the feed rolls is cancelled, the feed rolls are monitored for any rotational movement and, if a certain maximum permissible angle of twist is exceeded, the press is automatically stopped, in particular with an indication of the detected angle of twist via the press control system.

11. The method according to claim 10, wherein the monitoring starts with the start of the shifting of the following feed interval and ends at the end of the reduction or cancellation of the holding torque.

12. A machine tool, in particular for carrying out the method according to claim 1,
with a feed apparatus comprising at least one pair of feeding rollers between which the material strip can be clamped and by means of which it can be fed at intervals by rotating the feeding rollers at intervals, in particular driven by a servomotor, and can be held in the feed pauses with the material strip stationary and clamped between the feed rollers by fixing the feed rollers with a specific holding torque, wherein the feed apparatus is designed in such a way that in the feed pauses, when the material strip is stationary and clamped between the feed rollers, the holding torque of the feed rollers can be temporarily reduced or cancelled, so that the material strip can be displaced by forces acting on the material strip, with the feed rollers clamping the material strip being rotated by the material strip claimed between them,
and with one or more pilot pins for moving into associated pilot openings in the material strip for the purpose of positioning the material strip at temporarily reduced or cancelled holding torque,
wherein the machine tool comprises a control system with which the servo motor or the feed rollers can be controlled per feed interval according to a predetermined target movement and standstill profile,
and wherein the control system is designed in such a way that the actual movement and standstill profile of the servomotor or of the feed rollers can be monitored and the target movement and standstill profile of a subsequent feed interval, in particular of the next feed interval, can be shifted in such a way that the target position of the servomotor or of the feed rollers at the start of this shifted target movement and standstill profile is the actual position of the servomotor or of the feed rollers after positioning of the material strip with the pilot pin or pins.

13. The machine tool according to claim 12, wherein the feed apparatus is designed in such a way that the holding torque can be temporarily reduced to a certain value greater than zero.

14. The machine tool according to claim 12, wherein the feed apparatus is configured such that the holding torque can be temporarily cancelled.

15. The machine tool according to claim 13, wherein the feed apparatus comprises a servomotor for driving the feed rollers.

16. The machine tool according to claim 15, wherein the servomotor or the feed rollers can be controlled per feed interval with a control system according to a predetermined target movement and standstill profile.

17. (canceled)

18. (canceled)

19. The machine tool according to claim 12, wherein the machine tool is a punch press and wherein the target movement and standstill profile of the servomotor or the feed rollers can be synchronized with the motion profile of the press ram.

20. The machine tool according to claim 19, wherein the synchronization can be carried out as relative synchronization, so that in the target movement and standstill profile of the servo motor or the feed rollers it is possible to start and stop as desired.

21. The machine tool according to claim 12, wherein the machine tool is equipped in such a way that after the pilot pin or pins have been moved out of the pilot openings of the material strip and while the reduction of the holding torque of the feed rollers is cancelled, the feed rollers can be monitored for any rotational movement and, if a certain maximum permissible angle of rotation is exceeded, the press can be stopped automatically, in particular with visualization of the detected angle of rotation via the press control system.

22. The machine tool according to claim 21, wherein the machine tool is designed in such a way that the monitoring starts at the start of the displacement of the following feed interval and ends when the reduction or cancellation of the holding torque is cancelled.
